(19) United States
(12) Patent Application Publication
(10) Pub. No.: US 2026/0145661 A1
(43) Pub. Date: May 28, 2026

(54) ARCHITECTURES FOR VEHICLE-TO-VEHICLE CHARGING OR VEHICLE-TO-LOAD OPERATIONS

(71) Applicant: GM GLOBAL TECHNOLOGY OPERATIONS LLC, DETROIT, MI (US)

(72) Inventors: Rashmi Prasad, Troy, MI (US); Chandra S. Namuduri, Troy, MI (US); Merwyn Cheruvathur, Livonia, MI (US)

(21) Appl. No.: 18/956,542

(22) Filed: Nov. 22, 2024

(51) Int. Cl. B60W 20/00; B60L 53/14; B60L 53/57; B60L 53/62; B60L 53/66; H02J 7/14

(52) U.S. Cl. CPC B60W 20/00; B60L 53/14; B60L 53/57; B60L 53/62; B60L 53/66; H02J 7/14; B60L 2210/10; B60L 2220/12; B60W 2510/244

(57) ABSTRACT

Examples described herein provide a method for providing electrical power from a first vehicle to a second vehicle, the first vehicle being a hybrid electric vehicle. The method includes receiving, from the second vehicle by the first vehicle, a request for electrical power from the second vehicle, the second vehicle being electrically coupled to the first vehicle, the request defining a requested amount of electrical power. The method further includes generating, using a generator set associated with an internal combustion engine, electrical power substantially equal to the requested amount of electrical power. The method further includes transmitting, from the generator set to the second vehicle, the electrical power that is substantially equal to the requested amount of electrical power.

The subject disclosure relates to vehicles, and in particular to architectures for vehicle-to-vehicle charging or vehicle-to-load operations.

Modern vehicles (e.g., a car, a motorcycle, a boat, or any other type of automobile) may be equipped with one or more batteries to provide electrical power to various systems of the vehicle. For example, an electric vehicle may include one or more batteries to provide electrical power to one or more electric motors, which provide propulsion to the vehicle. This configuration of vehicle is referred to as a battery electric vehicle (BEV). Other types of vehicles may also be equipped with batteries, such as vehicles with combustion engines, hybrid-electric vehicles, and/or the like, including combinations and/or multiples thereof.

Vehicle-to-vehicle (V2V) charging is a technique for transferring stored electrical power from one vehicle (a source vehicle) to another vehicle (a destination vehicle). V2V charging may support bidirectional charging technology, enabling both charging and discharging of energy between vehicles. V2V charging can be particularly useful in emergency situations or remote areas where traditional charging infrastructure is unavailable. It operates via a direct current (DC) connection or an alternating current (AC) connection between the vehicles. Vehicles equipped with V2V capabilities can balance energy among themselves, potentially extending driving ranges or assisting vehicles with depleted batteries.

Vehicle to load (V2L) is a technique that transfers electrical power from the vehicle (the source vehicle) to an electrical load connected to the vehicle. For example, electrical power can be transferred from one or more batteries of the vehicle to a system or device connected to the vehicle that operates using the electrical power from the vehicle. This enables the vehicle to supply electrical power in various situations when electrical power may be unavailable, such as during a power outage, at a location without electrical power (e.g., a campsite, a construction site), and/or the like, including combinations and/or multiples thereof. As an example, a vehicle with V2L capabilities can be used to charge another electric vehicle. As another example, the vehicle can include one or more electrical outlets into which any suitable device can be plugged (e.g., a lamp, a coffee machine, an air compressor, and/or the like, including combinations and/or multiples thereof).

Vehicles with internal combustion engines, such as plugin hybrid electric vehicles and hybrid electrical vehicles, can use the internal combustion engines to generate electrical power, which can be used for V2V charging or V2L operations. It is desirable to provide an architecture for V2V charging or V2L operations that uses a direct power connection from a generator of the source vehicle to provide electrical power for V2V charging or V2L operations.

### SUMMARY

In one embodiment, a computer-implemented method for providing electrical power from a first vehicle to a second vehicle, the first vehicle being a hybrid electric vehicle, is provided. The method includes receiving, from the second vehicle by the first vehicle, a request for electrical power from the second vehicle, the second vehicle being electrically coupled to the first vehicle, the request defining a requested amount of electrical power. The method further includes generating, using a generator set associated with an internal combustion engine, electrical power substantially equal to the requested amount of electrical power. The method further includes transmitting, from the generator set to the second vehicle, the electrical power that is substantially equal to the requested amount of electrical power.

In addition to one or more of the features described herein, or as an alternative, further embodiments of the method may include that the generator set includes an inverter and at least one of an interior permanent magnet machine and an induction machine.

In addition to one or more of the features described herein, or as an alternative, further embodiments of the method may include that the generator set includes a separately excitable machine and an inverter with a direct current (DC)-DC converter, wherein the separately excitable machine regulates a magnitude and a frequency of the electrical power generated by running an internal combustion engine of the first vehicle while at a substantially constant speed while adjusting an excitation for maintaining a desired line voltage.

In addition to one or more of the features described herein, or as an alternative, further embodiments of the method may include that the second vehicle is electrically connected to an electric power takeoff port of the first vehicle.

In addition to one or more of the features described herein, or as an alternative, further embodiments of the method may include that the electric power takeoff port of the first vehicle supports discharge current and handshaking signals to allow for signal exchanges between the first vehicle and the second vehicle.

In addition to one or more of the features described herein, or as an alternative, further embodiments of the method may include that the second vehicle is electrically connected to a charging inlet via an onboard charging module of the first vehicle.

In addition to one or more of the features described herein, or as an alternative, further embodiments of the method may include that transmitting the electrical power is performed using direct current fast charging.

In addition to one or more of the features described herein, or as an alternative, further embodiments of the method may include that the generator set includes a three-terminal generator.

In addition to one or more of the features described herein, or as an alternative, further embodiments of the method may include that the generator set includes a four-terminal generator.

In addition to one or more of the features described herein, or as an alternative, further embodiments of the method may include receiving, from the second vehicle by the first vehicle, an updated request for electrical power, wherein the updated request specifies an updated requested amount of electrical power, adjusting the generator set to generate electrical power substantially equal to the updated requested amount of electrical power, and transmitting, from the generator set to the second vehicle, the electrical power that is substantially equal to the updated requested amount of electrical power.

In addition to one or more of the features described herein, or as an alternative, further embodiments of the method may include that the first vehicle supports multiple modes of operation including a vehicle-to-vehicle charging mode and a vehicle to load operation mode.

In another embodiment, a hybrid electric vehicle is provided. The vehicle includes an internal combustion engine, a generator set to convert mechanical energy generated by the internal combustion engine into electrical power, and a charging controller. The charging controller includes a processing device for executing the computer readable instructions, the computer readable instructions controlling the charging controller to perform operations for providing electrical power from the hybrid electric vehicle to a second vehicle. The operations include receiving, from the second vehicle by the hybrid electric vehicle, a request for electrical power from the second vehicle, the second vehicle being electrically coupled to the hybrid electric vehicle, the request defining a requested amount of electrical power. The operations further include causing generation of the electrical power by the generator set, the electrical power being substantially equal to the requested amount of electrical power. The operations further include causing transmission of the electrical power that is substantially equal to the requested amount of electrical power from the generator set to the second vehicle.

In addition to one or more of the features described herein, or as an alternative, further embodiments of the vehicle may include that the generator set includes an inverter and at least one of an interior permanent magnet machine and an induction machine.

In addition to one or more of the features described herein, or as an alternative, further embodiments of the vehicle may include that the generator set includes a separately excitable machine and an inverter with a direct current (DC)-DC converter, wherein the separately excitable machine regulates a magnitude and a frequency of the electrical power generated by running an internal combustion engine of the first vehicle while at a substantially constant speed while adjusting an excitation for maintaining a desired line voltage.

In addition to one or more of the features described herein, or as an alternative, further embodiments of the vehicle may include an electric power takeoff port, wherein the second vehicle is electrically connected to the electric power takeoff port.

In addition to one or more of the features described herein, or as an alternative, further embodiments of the vehicle may include that the electric power takeoff port of the hybrid electric vehicle supports discharge current and handshaking signals to allow for signal exchanges between the hybrid electric vehicle and the second vehicle.

In addition to one or more of the features described herein, or as an alternative, further embodiments of the vehicle may include an onboard charging module, wherein the second vehicle is electrically connected to a charging inlet via onboard charging module.

In addition to one or more of the features described herein, or as an alternative, further embodiments of the vehicle may include that the generator set includes a three-terminal generator.

In addition to one or more of the features described herein, or as an alternative, further embodiments of the vehicle may include that the generator set includes a four-terminal generator.

In another embodiment a computer program product for providing electrical power from a vehicle to a device while the vehicle is operating in a vehicle-to-load (V2L) mode is provided. The computer program product includes a set of one or more computer-readable storage media and program instructions, collectively stored in the set of one or more storage media, for causing a processor set to perform operations. The operations include receiving, from the device by the vehicle, a request for electrical power from the device, the device being electrically coupled to the vehicle, the request defining a requested amount of electrical power. The operations further include generating, using a generator set associated with an internal combustion engine, electrical power substantially equal to the requested amount of electrical power. The operations further include transmitting, from the generator set to the device, the electrical power that is substantially equal to the requested amount of electrical power.

The above features and advantages, and other features and advantages of the disclosure are readily apparent from the following detailed description when taken in connection with the accompanying drawings.

### BRIEF DESCRIPTION OF THE DRAWINGS

Other features, advantages and details appear, by way of example only, in the following detailed description, the detailed description referring to the drawings in which:

FIG. 1 is an illustration of a vehicle supporting architectures for vehicle-to-vehicle charging or vehicle-to-load according to one or more embodiments;

FIG. 2A is a block diagram of a system for vehicle-to-vehicle charging or vehicle-to-load according to one or more embodiments;

FIG. 2B is a block diagram of a system for vehicle-to-vehicle charging or vehicle-to-load according to one or more embodiments;

FIG. 3A is a block diagram of a circuit for vehicle-to-vehicle charging or vehicle-to-load according to one or more embodiments;

FIG. 3B is a block diagram of a circuit for vehicle-to-vehicle charging or vehicle-to-load according to one or more embodiments;

FIG. 3C is a block diagram of a circuit for vehicle-to-vehicle charging or vehicle-to-load according to one or more embodiments;

FIG. 3D is a block diagram of a circuit for vehicle-to-vehicle charging or vehicle-to-load according to one or more embodiments;

FIG. 3E is a block diagram of a circuit for vehicle-to-vehicle charging or vehicle-to-load according to one or more embodiments; and

FIG. 4 is a flow diagram of a method for vehicle-to-vehicle charging or vehicle-to-load according to one or more embodiments.

### DETAILED DESCRIPTION

The following description is merely exemplary in nature and is not intended to limit the present disclosure, its application or uses. It should be understood that throughout the drawings, corresponding reference numerals indicate like or corresponding parts and features. As used herein, the term module refers to processing circuitry that may include an application specific integrated circuit (ASIC), an electronic circuit, a processor (shared, dedicated, or group) and memory that executes one or more software or firmware programs, a combinational logic circuit, and/or other suitable components that provide the described functionality.

As used herein, the term “controller” (e.g., a charging controller as further described herein) refers to a dedicated controller including a processor and a memory, a general controller including control modules configured to enact a control process using the dedicated controller, a network of multiple distinct controllers in communication with each other and each including processors and memory and being configured to cooperatively implement the control process, and any similar configuration for implementing the control process.

One or more embodiments described herein provides architectures that provide vehicle-to-vehicle charging or vehicle-to-load. For example, a vehicle can be configured to provide direct current (DC) electrical power (e.g., substantially 400-800 V) and/or alternating current (AC) electrical power (e.g., substantially 110-120 Vac and/or substantially 220-240 Vac) to another vehicle or load electrically connected to a vehicle. According to one or more embodiments, one or more embodiments described herein may be implemented at other AC and/or DC voltage levels.

The propulsion systems of existing hybrid electric vehicles (HEVs) and existing plug-in hybrid electric vehicles (PHEVs) use an onboard charging module (OBCM) to charge a battery of the vehicle from the electrical grid. When performing V2V charging, the vehicle (e.g., a HEV or PHEV) often employs a DC-DC converter to provide electrical power from the source vehicle (e.g., the vehicle providing electrical power) to the destination vehicle (e.g., the vehicle receiving the electrical power from the source vehicle). Such DC-DC converter can be a bi-directional DC-DC converter, a fuel cell DC-DC converter, and/or the like, including combinations and/or multiples thereof. Such HEVs or PHEVs can use an offboard V2V charging architecture in some cases or can use a multifunction electronic drive system with increased power capabilities for V2V DC charging in electric vehicles.

However, each of these existing approaches utilizes the DC-DC converter, which adds weight, complexity, and additional inefficiencies to the vehicle. It is desirable to provide an architecture for V2V charging or V2L operations that uses a direct power connection from a generator of the source vehicle to provide electrical power for V2V charging or V2L operations without the DC-DC converter of existing approaches.

One or more embodiments described herein address these and other shortcomings by providing architectures for vehicle-to-vehicle charging or vehicle-to-load. According to one or more embodiments, an electrical architecture is provided that enables V2V DC charging in a plug-in hybrid electric vehicle (PHEV) or a hybrid electric vehicle (HEV) with an internal combustion engine (ICE) driven motor-generator with inverter that regulates the charging voltage and current. That is, one or more embodiments enables a PHEV or HEV that includes an ICE, a generator set (gen set), and an inverter to directly charge another vehicle at the power that the generator is capable of producing. One or more embodiments provides for direct power connection from the gen set in a V2x alternating current (AC) mode. One or more embodiments eliminates the DC-DC converter conventionally implemented for V2V charging and/or V2L operations.

One or more embodiments described herein can be applied to any suitable hybrid vehicle, such as mild hybrids, full hybrids (e.g., parallel hybrids and series hybrids), plug-in hybrids, electric vehicles with range extender hybrids, and/or the like, including combinations and/or multiples thereof.

It should be appreciated that the functioning of any vehicle implementing one or more of the embodiments described herein is improved. More particularly, one or more embodiments described herein offer significant benefits and advantages, particularly in enhancing the functionality of hybrid electric vehicles. For example, by integrating a direct power connection from a generator set, these embodiments eliminate the need for a conventional DC-DC converter, reducing weight, complexity, and inefficiencies. This streamlined architecture enables V2V charging and V2L operations more efficiently, providing a cost-effective solution that minimizes additional hardware requirements. One or more embodiments provide the ability to adjust output voltage and current based on recipient requests, which ensures optimal power distribution, enhancing the vehicle's adaptability to various charging scenarios. Furthermore, the use of a separately excitable machine or an interior permanent magnet machine allows for precise regulation of power output, improving the overall energy management within the vehicle. These innovations not only improve the vehicle's operational efficiency but also extend its utility in diverse environments by providing improved functionality, offering users greater flexibility and reliability in power management.

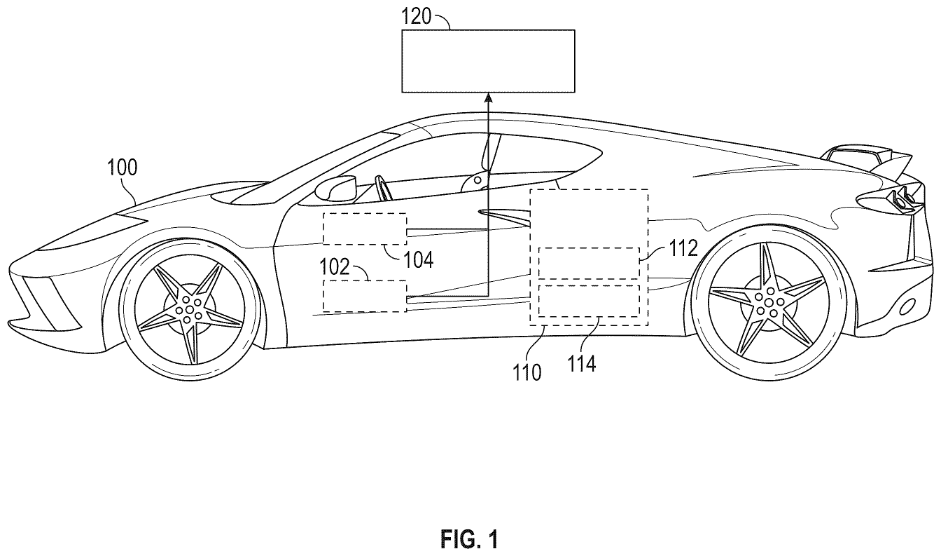

FIG. 1 is an illustration of a vehicle 100 supporting architectures for vehicle-to-vehicle charging or vehicle-to-load according to one or more embodiments. The vehicle 100 serves as an example platform for implementing the described architectures for vehicle-to-vehicle charging or vehicle-to-load. The vehicle 100 integrates various components to facilitate these functionalities, including a battery 102, an ICE 104, and a charging controller 110. The vehicle 100 can be any type of automobile, such as a car, truck, van, bus, motorcycle, or boat. The vehicle 100 may be powered by gasoline, diesel, or a combination of electrical power from the battery 102 and the ICE 104, as seen in HEVs or PHEVs.

The battery 102 represents one or more batteries within the vehicle 100. The battery 102 can be a single battery, multiple batteries, or a battery system. The battery 102 receives electrical power from various sources, such as an AC grid or an alternator or generator of the vehicle 100. The battery 102 supplies electrical power to an electric motor for vehicle propulsion, internal systems like infotainment or climate control, external systems or devices connected to the vehicle 100 (V2L operations), other vehicles connected to the vehicle 100 (e.g., V2V charging), such as the charging external vehicle 120, and/or the like, including combinations and/or multiples thereof. The battery 102 also supports V2V charging by supplying power to a charging external vehicle 120, or V2L operations by supplying power to external systems or devices.

The internal combustion engine (ICE) 104 is a component of the vehicle 100, providing mechanical power that can be converted into electrical power for various applications. The ICE 104 can be fueled by gasoline, diesel, or other suitable fuels. In the context of V2V and V2L operations, the ICE 104 works in conjunction with other components (e.g., a generator and an inverter) to generate and regulate electrical power, which can be used to charge the battery 102 or supply power to external loads.

The charging controller 110 is responsible for managing the charging processes within the vehicle 100. The charging controller 110 includes a processor 112 and a memory 114, which store and execute computer-readable instructions to control the charging operations. The charging controller 110 communicates with other components, such as the ICE 104 and the battery 102, to adjust output voltage and current based on the requirements of the recipient vehicle (e.g., the charging external vehicle 120) or load. The charging controller 110 ensures efficient power distribution and management during V2V charging and V2L operations.

The processor 112 within the charging controller 110 executes the instructions stored in the memory 114 to perform various operations related to charging control. The processor 112 processes data and signals from other components to make real-time adjustments to the charging parameters, ensuring optimal performance and safety during power transfer. The processor 112 can be one or more devices that can be implemented using various types of hardware, such as microcontrollers, application-specific integrated circuits (ASICs), field-programmable gate arrays (FPGAs), system-on-a-chip (SOC), and/or the like, including combinations and/or multiples thereof.

The memory 114 stores the computer-readable instructions that the processor 112 executes. The memory 114 may also store data related to charging operations, such as voltage and current levels, state of charge (SOC), and other relevant parameters. The memory 114 enables the charging controller 110 to perform the functions of the charging controller 110 effectively by providing the necessary instructions and data storage capabilities. The memory 114 can be one or more devices that can implement various types of storage hardware, such as flash memory, random-access memory, read-only memory, and/or the like, including combinations and/or multiples thereof.

The charging external vehicle 120, also referred to as the destination vehicle, receives electrical power from the vehicle 100 during V2V charging operations. The charging external vehicle 120 connects to the vehicle 100 through appropriate interfaces and cables, allowing for the transfer of electrical power. The charging controller 110 manages the power transfer to ensure compatibility and efficiency, adjusting the output based on the recipient's requests.

According to one or more embodiments, the vehicle 100 includes a generator, driven by ICE 104, and an inverter to enable V2V DC charging by exporting power through a DC fast charge port or an electric power takeoff (ePTO) port of the vehicle 100.

According to one or more embodiments, the vehicle 100 can include multiple controllers, including an engine controller (not shown) for controlling ICE 104, an inverter controller (not shown), and the charging controller 110. These controllers communicate, such as via a communication bus, to adjust the output voltage and current based on the requests from the charging external vehicle 120.

According to one or more embodiments, the architectures described herein allow a direct power connection to the charging external vehicle 120 from a generator in a V2x AC mode.

One or more embodiments of the vehicle 100 provide a mode switching strategy between different operating conditions of the vehicle 100.

According to one or more embodiments, the battery 102 may be selectively disconnected from a propulsion bus (not shown) of the vehicle 100 during the V2x mode using the generator (e.g., a generator set). According to one or more embodiments, the battery 102 can be used in conjunction with dual propulsion motors and inverters as buck, boost, or buck-boost converters for V2V DC fast charging using energy available from the battery 102.

According to one or more embodiments, the generator set can use an interior permanent magnet (IPM) machine and/or a separately excitable machine (SEM). The SEM-based generator set can be used to regulate both the magnitude and frequency of the alternating current generated by running the ICE 104 at a constant speed for substantially 60 Hz and adjusting the excitation for maintaining desired line to line voltage (e.g., 240 Vrms).

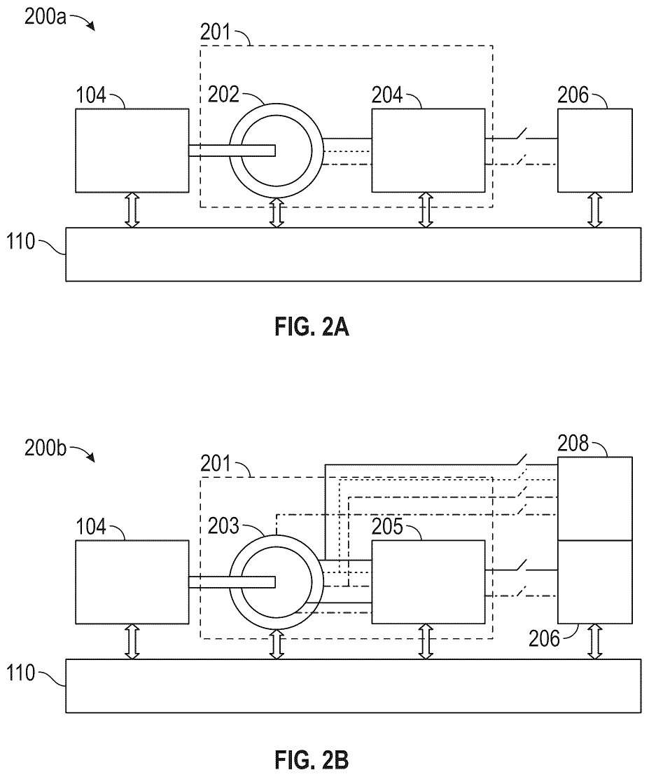

FIG. 2A is a block diagram of a system 200a for vehicle-to-vehicle charging or vehicle-to-load according to one or more embodiments. System 200a includes ICE 104, IPM machine 202, inverter 204, V2X DC fast charger (DCFC) 206, and charging controller 110. These components interact to facilitate the transfer of electrical power between vehicles or to external loads.

ICE 104 provides mechanical power that can be converted into electrical power. ICE 104 connects to IPM machine 202, which manages the conversion of mechanical energy into electrical energy. ICE 104 can operate using various fuels, such as gasoline or diesel, to generate the necessary power for the system.

IPM machine 202 interfaces with ICE 104 to convert mechanical power into electrical power. IPM machine 202 regulates the power flow and ensures efficient energy conversion. IPM machine 202 connects to inverter 204, facilitating the transformation of electrical power into a suitable form for further processing.

Inverter 204 receives electrical power from IPM machine 202 and converts the electrical power into a form suitable for V2X DCFC 206. Inverter 204 plays a role in adapting the power for vehicle-to-vehicle charging or vehicle-to-load applications. Inverter 204 ensures that the power is compatible with the requirements of the connected systems.

Together, the IPM machine 202 and the inverter 204 represents an example of a generator set (gen set) 201.

V2X DCFC 206 connects to inverter 204 to facilitate direct current fast charging. V2X DCFC 206 enables rapid power transfer to other vehicles or external loads, supporting efficient energy distribution. V2X DCFC 206 supports quick and effective charging operations. According to one or more embodiments, the charging external vehicle 120 of FIG. 1 connects directly or indirectly to the V2X DCFC 206 to exchange electrical power.

Charging controller 110 manages the overall operation of system 200a. Charging controller 110 coordinates the interactions between ICE 104, IPM machine 202, inverter 204, and V2X DCFC 206. Charging controller 110 ensures optimal performance and safety during power transfer, adjusting parameters as needed.

FIG. 2B is a block diagram of a system 200b for vehicle-to-vehicle charging or vehicle-to-load according to one or more embodiments. System 201b includes ICE 104, charging controller 110, SEM 203, inverter+DC-DC converter 205, V2X DCFC 206, and V2X AC 208. These components interact to facilitate the transfer of electrical power between vehicles or to external loads.

Charging controller 110 manages the overall operation of system 201b. Charging controller 110 coordinates the interactions between ICE 104, SEM 203, inverter+DC-DC converter 205, V2X DCFC 206, and V2X AC 208. Charging controller 110 ensures optimal performance and safety during power transfer, adjusting parameters as needed.

SEM 203 interfaces with ICE 104 to convert mechanical power into electrical power. SEM 203 can be any kind of machine to be used as generator including a permanent magnet motor, induction motor, separately excited machine or others. SEM 203 regulates the power flow and ensures efficient energy conversion. SEM 203 connects to inverter +DC-DC converter 205, facilitating the transformation of electrical power into a suitable form for further processing. According to one or more embodiments, the SEM can use pulse width modulation (PWM) scheduling for low losses and/or ripple and to overall improve efficiency and durability.

Inverter+DC-DC converter 205 receives electrical power from SEM 203 and converts the electrical power into a form suitable for V2X DCFC 206. Inverter+DC-DC converter 205 plays a role in adapting the power for vehicle-to-vehicle charging or vehicle-to-load applications. Inverter+DC-DC converter 205 ensures that the power is compatible with the requirements of the connected systems.

Together, SEM 203 and inverter+DC-DC converter 205 represents an example of a generator set (gen set) 201.

V2X DCFC 206 connects to inverter+DC-DC converter 205 to facilitate direct current fast charging. V2X DCFC 206 enables rapid power transfer to other vehicles or external loads, supporting efficient energy distribution. V2X DCFC 206 supports quick and effective charging operations.

V2X AC 208 connects to SEM 203 to provide alternating current power to external loads while bypassing inverter +DC-DC converter 205. V2X AC 208 enables the system to supply AC power for V2L operations, expanding the range of devices and systems that can be powered by the vehicle 100.

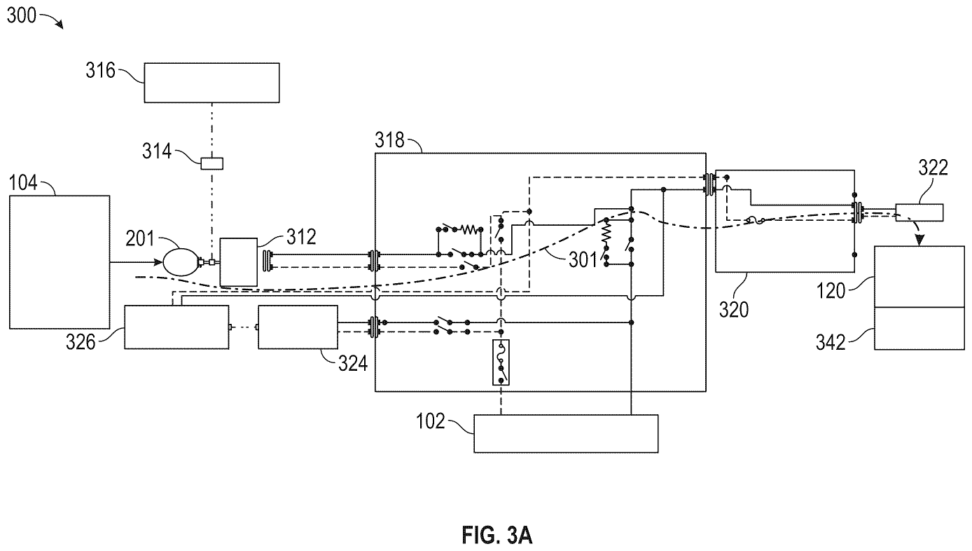

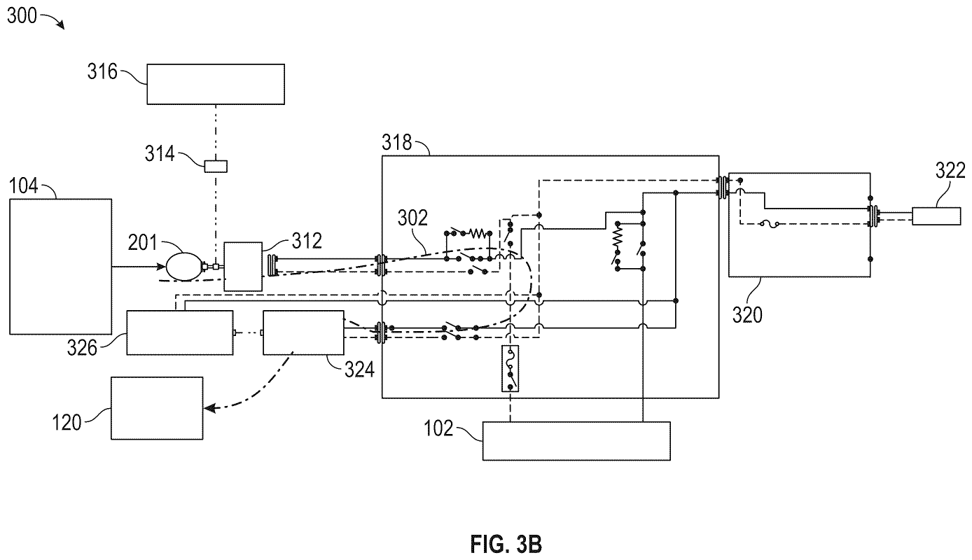

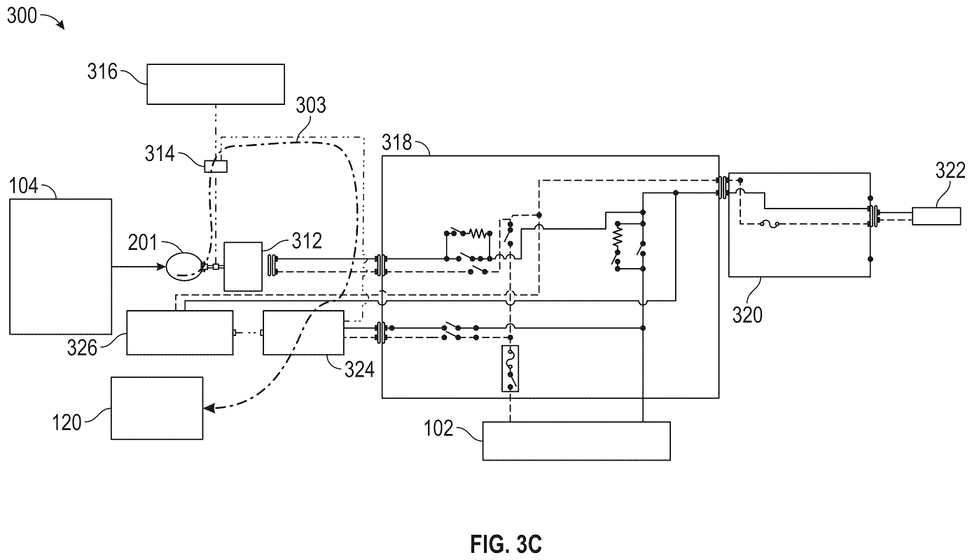

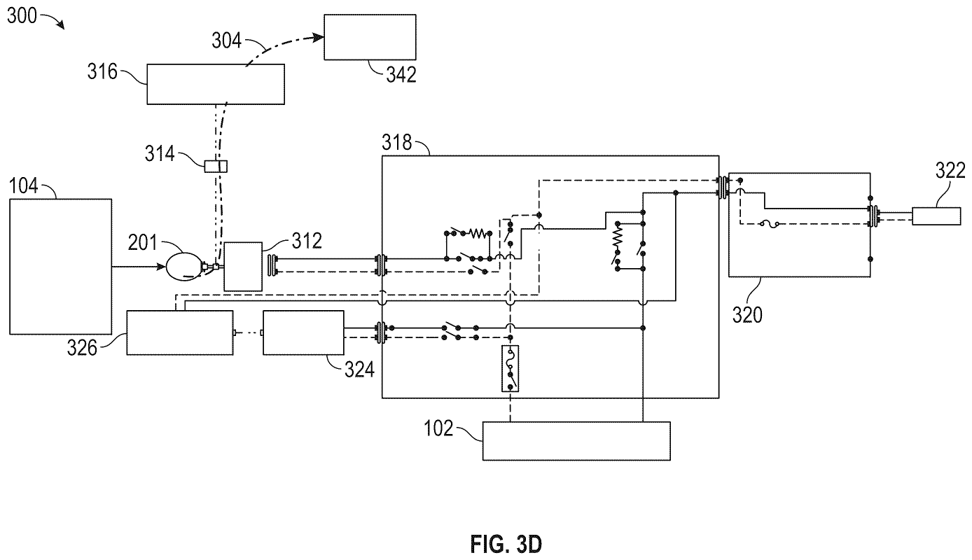

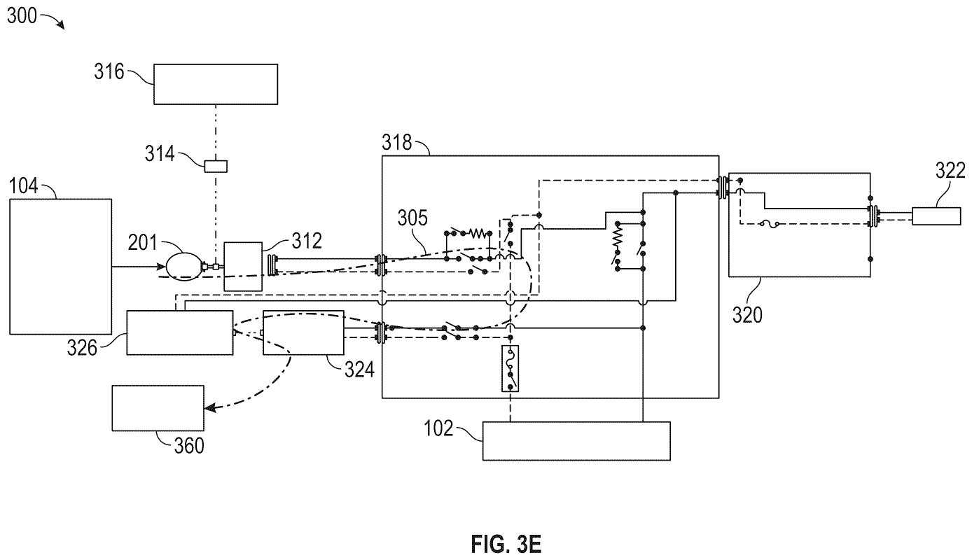

FIGS. 3A-3E are now described together. Particularly, FIGS. 3A-3E depict a circuit 300 for vehicle-to-vehicle charging, vehicle-to-load, or vehicle-to-everything (V2x) according to one or more embodiments. Each of FIGS. 3A-3E depicts a path for the flow of electrical energy from the ICE 104 of the vehicle 100 to the charging external vehicle 120. For example, FIG. 3A depicts path 301, FIG. 3B depicts path 302, FIG. 3C depicts path 303, FIG. 3D depicts path 304, and FIG. 3E depicts path 305.

The circuit 300 includes ICE 104, battery 102, a generator set (gen set) 201, an inverter 312, an AC line filter+relay/fuse 314, onboard power outlets 316, a junction box 318, a fuse box 320, an ePTO port 322, a charging inlet 324, and an onboard charging module (OBCM) 326. These components interact to facilitate the transfer of electrical power between vehicles (e.g., between the vehicle 100 and the charging external vehicle 120) or to external loads (e.g., from the vehicle 100 to an external load 342).

ICE 104 provides mechanical power that can be converted into electrical power. ICE 104 connects to gen set 201, which manages the conversion of mechanical energy into electrical energy. Gen set 201 interfaces with ICE 104 to convert mechanical power into electrical power. Gen set 201 regulates the power flow and ensures efficient energy conversion. Gen set 201 connects to AC line filter +relay/fuse 314, which facilitates the transformation of electrical power into a suitable form for V2L operations via the onboard power outlets 316.

Gen set 201 is also connected to inverter 312 to provide direct current power to external loads, such as the charging external vehicle 120. Inverter 312 connects to junction box 318, which includes various electronics components, such as switches, wires, relays, resistors, fuses, and/or the like, including combinations and/or multiples thereof.

Junction Box 318 is connected to fuse box 320, which also connects to ePTO port 322 to provide protection for the circuit 300, the vehicle 100, and the charging external vehicle 120. Fuse Box 320 ensures that the system operates safely by preventing overloads and short circuits.

Charging external vehicle 120 receives electrical power from ePTO port 322 during vehicle-to-vehicle charging operations. Charging external vehicle 120 connects to the vehicle 100 through appropriate interfaces and cables as shown in FIGS. 3A-3E, allowing for the transfer of electrical power to the charging external vehicle 120 from the gen set 201 of the vehicle 100.

In some embodiments, such as shown in FIG. 3A, the charging external vehicle 120 is connected to the ePTO port 322.

In other embodiments, such as shown in FIGS. 3B and 3C, the charging external vehicle 120 is connected to a charging inlet 324, which delivers the electric power to the charging external vehicle 120.

Various paths, including paths 301, 302, 303, 304, and 305, can be used to provide electrical power to the charging external vehicle 120 according to different operating scenarios, which are now described in more detail with reference to FIGS. 3A-3E.

Particularly, with reference to FIG. 3A, path 301 represents the flow of electrical power within the circuit 300 from gen set 201 to the charging external vehicle 120 via the ePTO port 322. Path 301 connects various components, ensuring that power is distributed efficiently and effectively.

The embodiment of FIG. 3A provides V2V charging via the ePTO port 322, as shown by path 301. In this embodiment, the battery 102 selectively may be disconnected from the propulsion bus (not shown) during a V2x mode of operation via gen set 201 or the power may also be provided at ePTO port 322 by both battery 102 and gen set 201 together or by the battery 102 alone for a limited time. An engine controller (not shown) that controls ICE 104 and an inverter controller (not shown) that controls the inverter of the gen set 201 (e.g., the inverter 204 of FIG. 2A) communicate with the charging controller 110 to adjust the output voltage and current delivered at ePTO port 322 based on requests from the charging external vehicle 120. ePTO port 322 allows for V2x discharge current and handshaking signals allow for specific signal exchanges between the vehicle 100 and the charging external vehicle 120, such as request for voltage, current, power/energy, state of change, and/or the like, including combinations and/or multiples thereof. It should be appreciated that no additional DC-DC converter is implemented in the embodiment of FIG. 3A as is often used in fuel cell electric vehicles (FCEVs).

With reference to FIG. 3B, path 302 represents the flow of electrical power within the circuit 300 from gen set 201 to the charging external vehicle 120 via the charging inlet 324. Path 302 connects various components, ensuring that power is distributed efficiently and effectively.

The embodiment of FIG. 3B provides V2V charging by routing electrical power from gen set 201, bypassing the battery 102, via the charging inlet 324, as shown by path 302. In this embodiment, the battery 102 may be disconnected from the propulsion bus (not shown) during a V2x mode of operation via gen set 201. An engine controller (not shown) that controls ICE 104 and an inverter controller (not shown) that controls the inverter of the gen set 201 (e.g., the inverter 204 of FIG. 2A) communicate with the charging controller 110 to adjust the output voltage and current at charging inlet 324 based on requests from the charging external vehicle 120. The battery 102 is disconnected from the propulsion bus when exporting power in V2V charging (e.g., direct current fast charging mode) using power purely from gen set 201 according to one or more embodiments. The exported power can also be provided by both gen set 201 and battery 102 together according to one or more embodiments.

With reference to FIG. 3C, path 303 represents the flow of electrical power within the circuit 300 from gen set 201, through the AC line filter+relay/fuse 314, to the charging external vehicle 120 via the charging inlet 324. Path 303 connects various components, ensuring that power is distributed efficiently and effectively.

The embodiment of FIG. 3C provides V2V charging by routing electrical power from gen set 201, bypassing the battery 102, via the charging inlet 324, as shown by path 303. This example provides V2V AC charging using an AC charge port by routing AC power from gen set 201 before feeding the inverter. An engine controller (not shown) that controls ICE 104 and an inverter controller (not shown) that controls the inverter of the gen set 201 (e.g., the inverter 204 of FIG. 2A) communicate with the charging controller 110 to adjust the output voltage and current delivered at charging inlet 324 based on requests from the charging external vehicle 120. The generator of gen set 201 can be a four terminal generator with a neutral for substantially 120VAC single phase output. According to one or more embodiments, the generator of gen set 201 can provide three phase output, and two of the three phases can be used for split phase substantially 120VAC and substantially 208VAC.

With reference to FIG. 3D, path 304 represents the flow of electrical power within the circuit 300 from gen set 201, through the AC line filter+relay/fuse 314, to the external load 342 via the onboard power outlets 316. Path 304 connects various components, ensuring that power is distributed efficiently and effectively.

The embodiment of FIG. 3D provides V2L charging by routing electrical power from gen set 201 to external load 342 via onboard power outlets 316, as shown by path 304. This example provides high-powered V2L operation (e.g., substantially 120V, substantially 208V, etc.) using relays by routing AC power from the generator of gen set 201 directly to onboard power outlets 316 to provide power to external load 342 electrically coupled to the onboard power outlets 316. An engine controller (not shown) that controls ICE 104 communicate with the charging controller 110 to adjust the output voltage and current at onboard power outlets 316. In this embodiment, SEM 203 can be used as a generator that can regulate both the magnitude and frequency of the AC generated by running ICE 104 at a constant speed for substantially 60 Hz and adjusting the excitation of SEM 203 to provide substantially 120VAC single phase output or use two of the 3 phases to provide split phase substantially 120VAC and substantially 208VAC when using V2L operations through the generator. According to one or more embodiments, the relays may bypass the propulsion bus when routing the electrical power from the SEM 203 (e.g., the gen set 201) to the external load 342.

With reference to FIG. 3E, path 305 represents the flow of electrical power within the circuit 300 from gen set 201 to a vehicle-to-everything (V2x) device 360 via a DC bus to the OBCM 326 and charging inlet 324 as shown. Path 305 connects various components, ensuring that power is distributed efficiently and effectively.

The embodiment of FIG. 3E provides V2x charging by routing electrical power from gen set 201, bypassing the battery 102, via the OBCM 326, as shown by path 305. In this embodiment, the battery 102 is disconnected from the propulsion bus (not shown) during a V2x mode of operation via gen set 201. An engine controller (not shown) that controls ICE 104 and an inverter controller (not shown) that controls the inverter of the gen set 201 (e.g., the inverter 204 of FIG. 2A) communicate with the charging controller 110 to adjust the output voltage and current at OBCM 326 based on requests from the V2x device 360.

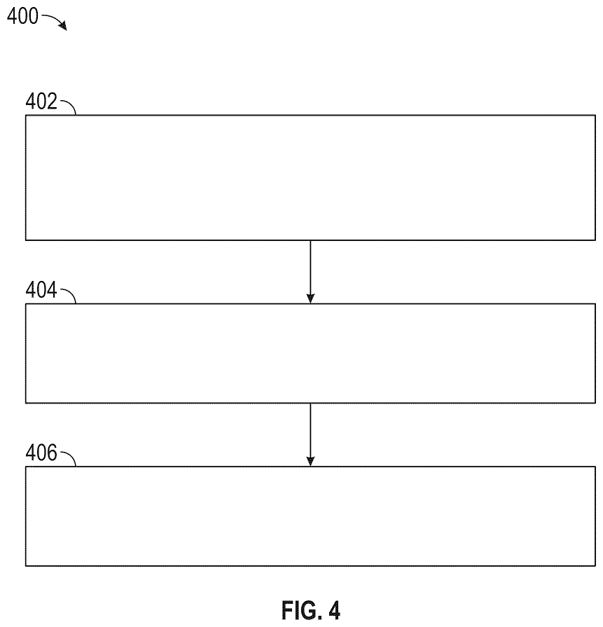

FIG. 4 illustrates a flow diagram of a method 400 for vehicle-to-vehicle charging or vehicle-to-load according to one or more embodiments. The method 400 can be implemented by any suitable system or device, such as the charging controller 110.

The method 400 begins at block 402, where a first vehicle (e.g., the vehicle 100) receives a request for electrical power from a second vehicle (e.g., the charging external vehicle 120). The second vehicle is electrically coupled to the first vehicle, and the request defines a requested amount of electrical power.

At block 404, the method 400 generates electrical power using gen set 201 associated with ICE 104. The generated electrical power is substantially equal to the requested amount of electrical power.

At block 406, the method 400 transmits the electrical power from gen set 201 to the charging external vehicle, such as using one or more of the paths 301-303 of FIGS. 3A-3C. The transmitted electrical power is substantially equal to the requested amount of electrical power.

Additional processes also may be included, and it should be understood that the process depicted in FIG. 4 represents an illustration, and that other processes may be added or existing processes may be removed, modified, or rearranged without departing from the scope of the present disclosure. It should also be understood that the processes depicted in FIG. 4 may be implemented as programmatic instructions stored on a non-transitory computer-readable storage medium that, when executed by a processor (e.g., the processor 112 of FIG. 1) of a computing system (e.g., the charging controller 110 of FIG. 1), cause the processor to perform the processes described herein.

The terms “a” and “an” do not denote a limitation of quantity, but rather denote the presence of at least one of the referenced item. The term “or” means “and/or” unless clearly indicated otherwise by context. Reference throughout the specification to “an aspect”, means that a particular element (e.g., feature, structure, step, or characteristic) described in connection with the aspect is included in at least one aspect described herein, and may or may not be present in other aspects. In addition, it is to be understood that the described elements may be combined in any suitable manner in the various aspects.

When an element such as a layer, film, region, or substrate is referred to as being “on” another element, it can be directly on the other element or intervening elements may also be present. In contrast, when an element is referred to as being “directly on” another element, there are no intervening elements present.

Unless specified to the contrary herein, all test standards are the most recent standard in effect as of the filing date of this application, or, if priority is claimed, the filing date of the earliest priority application in which the test standard appears.

Unless defined otherwise, technical and scientific terms used herein have the same meaning as is commonly understood by one of skill in the art to which this disclosure belongs.

While the above disclosure has been described with reference to exemplary embodiments, it will be understood by those skilled in the art that various changes may be made and equivalents may be substituted for elements thereof without departing from its scope. In addition, many modifications may be made to adapt a particular situation or material to the teachings of the disclosure without departing from the essential scope thereof. Therefore, it is intended that the present disclosure not be limited to the particular embodiments disclosed, but will include all embodiments falling within the scope thereof.

What is claimed is:

1. A computer-implemented method for providing electrical power from a first vehicle to a second vehicle, the first vehicle being a hybrid electric vehicle, comprising:
receiving, from the second vehicle by the first vehicle, a request for electrical power from the second vehicle, the second vehicle being electrically coupled to the first vehicle, the request defining a requested amount of electrical power;
generating, using a generator set associated with an internal combustion engine, electrical power substantially equal to the requested amount of electrical power; and
transmitting, from the generator set to the second vehicle, the electrical power that is substantially equal to the requested amount of electrical power.

2. The computer-implemented method of claim 1, wherein the generator set comprises an inverter and at least one of an interior permanent magnet machine and an induction machine.

3. The computer-implemented method of claim 1, wherein the generator set comprises a separately excitable machine and an inverter with a direct current (DC)-DC converter, wherein the separately excitable machine regulates a magnitude and a frequency of the electrical power generated by running an internal combustion engine of the first vehicle while at a substantially constant speed while adjusting an excitation for maintaining a desired line voltage.

4. The computer-implemented method of claim 1, wherein the second vehicle is electrically connected to an electric power takeoff port of the first vehicle.

5. The computer-implemented method of claim 4, wherein the electric power takeoff port of the first vehicle supports discharge current and handshaking signals to allow for signal exchanges between the first vehicle and the second vehicle.

6. The computer-implemented method of claim 1, wherein the second vehicle is electrically connected to a charging inlet via an onboard charging module of the first vehicle.

7. The computer-implemented method of claim 1, wherein transmitting the electrical power is performed using direct current fast charging.

8. The computer-implemented method of claim 1, wherein the generator set comprises a three-terminal generator.

9. The computer-implemented method of claim 1, wherein the generator set comprises a four-terminal generator.

10. The computer-implemented method of claim 1, further comprising:
receiving, from the second vehicle by the first vehicle, an updated request for electrical power, wherein the updated request specifies an updated requested amount of electrical power;
adjusting the generator set to generate electrical power substantially equal to the updated requested amount of electrical power; and
transmitting, from the generator set to the second vehicle, the electrical power that is substantially equal to the updated requested amount of electrical power.

11. The computer-implemented method of claim 1, wherein the first vehicle supports multiple modes of operation including a vehicle-to-vehicle charging mode and a vehicle to load operation mode.

12. A hybrid electric vehicle comprising:
an internal combustion engine;
a generator set to convert mechanical energy generated by the internal combustion engine into electrical power; and
a charging controller comprising:
a memory comprising computer readable instructions; and
a processing device for executing the computer readable instructions, the computer readable instructions controlling the charging controller to perform operations for providing electrical power from the hybrid electric vehicle to a second vehicle, the operations comprising:
receiving, from the second vehicle by the hybrid electric vehicle, a request for electrical power from the second vehicle, the second vehicle being electrically coupled to the hybrid electric vehicle, the request defining a requested amount of electrical power;
causing generation of the electrical power by the generator set, the electrical power being substantially equal to the requested amount of electrical power; and
causing transmission of the electrical power that is substantially equal to the requested amount of electrical power from the generator set to the second vehicle.

13. The hybrid electric vehicle of claim 12, wherein the generator set comprises an inverter and at least one of an interior permanent magnet machine and an induction machine.

14. The hybrid electric vehicle of claim 12, wherein the generator set comprises a separately excitable machine and an inverter with a direct current (DC)-DC converter, wherein the separately excitable machine regulates a magnitude and a frequency of the electrical power generated by running an internal combustion engine of the first vehicle while at a substantially constant speed while adjusting an excitation for maintaining a desired line voltage.

15. The hybrid electric vehicle of claim 12, further comprising an electric power takeoff port, wherein the second vehicle is electrically connected to the electric power takeoff port.

16. The hybrid electric vehicle of claim 15, wherein the electric power takeoff port of the hybrid electric vehicle supports discharge current and handshaking signals to allow for signal exchanges between the hybrid electric vehicle and the second vehicle.

17. The hybrid electric vehicle of claim 12, further comprising an onboard charging module, wherein the second vehicle is electrically connected to a charging inlet via onboard charging module.

18. The hybrid electric vehicle of claim 12, wherein the generator set comprises a three-terminal generator.

19. The hybrid electric vehicle of claim 12, wherein the generator set comprises a four-terminal generator.

20. A computer program product for providing electrical power from a vehicle to a device while the vehicle is operating in a vehicle-to-load (V2L) mode, the computer program product comprising:
a set of one or more computer-readable storage media;
program instructions, collectively stored in the set of one or more storage media, for causing a processor set to perform the following computer operations:
receiving, from the device by the vehicle, a request for electrical power from the device, the device being electrically coupled to the vehicle, the request defining a requested amount of electrical power;
generating, using a generator set associated with an internal combustion engine, electrical power substantially equal to the requested amount of electrical power; and
transmitting, from the generator set to the device, the electrical power that is substantially equal to the requested amount of electrical power.
